(19) United States
(12) Patent Application Publication
(10) Pub. No.: US 2025/0283386 A1
(43) Pub. Date: Sep. 11, 2025

(54) TUBING HANGER WITH SLEEVED ANNULUS ISOLATION DEVICE AND DYNAMIC METAL SEAL ELEMENTS

(71) Applicant: BAKER HUGHES ENERGY TECHNOLOGY UK LIMITED, Bristol (GB)

(72) Inventor: Michael SHAW, Aberdeen Aberdeenshire (GB)

(21) Appl. No.: 18/861,422

(22) PCT Filed: Apr. 27, 2023
(86) PCT No.: PCT/EP2023/025194

§ 371 Date: Oct. 29, 2024

(30) Foreign Application Priority Data
May 3, 2022 (GB) 2206402.6

(51) Int. Cl. E21B 33/04; F16J 15/34

(52) U.S. Cl. CPC E21B 33/04; F16J 15/34

(57) ABSTRACT

A tubing hanger comprising an annulus communication cavity and an annulus isolation device (AID) disposed within the cavity. The AID is operable to move between a closed position in which fluid communication to a downhole annulus via the cavity is prevented and an open position in fluid communication to the downhole annulus via the cavity is permitted. A metal sleeve surrounds the AID and is disposed between the AID and a surface defining the cavity. The AID further comprises one or more metal seal elements that form a dynamic metal-to-metal (MtM) seal with the metal sleeve. The present disclosure also relates to the metal seal element.

### TECHNICAL FIELD

The present disclosure relates to a tubing hanger and a wellhead assembly including the same. The present disclosure also relates to a metal seal element that provides a dynamic metal-to-metal (MtM) seal e.g., for use in the tubing hanger and wellhead assembly.

### BACKGROUND

In gas and oil drilling and production operations, wellheads are commonly defined at an upper end of a wellbore formed around a hydrocarbon producing formation. The wellhead typically includes a wellhead assembly that defines a housing having a tubing hanger mounted (or landed) therein. The purpose of the tubing hanger is to support a tubing string extending downhole into the wellbore for drilling or production. An annulus (or annular void) is commonly defined between the tubing string and the wellhead housing and can contain fluids used during drilling and production operations (e.g., drilling fluid, mud/sand etc.) known as annular fluids. Access to the annulus and thus annuluar fluids is blocked by the tubing hanger. Such access can be required during operation for a variety of reasons, such as supplying or removing annular fluids, and for testing and monitoring the same.

It is known to provide an annulus communication cavity within the tubing hanger that can selectively allow access (e.g., selectively allow fluid communication) between an uphole location (away from the wellbore) and the annulus. Control of access to the annulus is controlled by the movement of an annulus isolation device (“AID”) disposed within the annulus communication cavity. The AID acts as a valve element that can be actuated to control access to the annulus and annular fluid therein.

AIDs often employ dynamic seal elements to provide a moveable seal between the AID and the tubing hanger that permits the selective prevention of access between the annulus communication cavity and the annulus.

Metal-to-metal (MtM) seals are the preferred choice for such moveable seals due to the potential temperature limitations, chemical compatibility, and explosive decompression issues that non-metallic seals have been known to suffer from. However, providing such dynamic metal-to-metal (MtM) seals requires complex and tightly controlled surface profiles that are defect-free and may need to include low friction coatings. This adds significant complexity to the manufacture and maintenance of the tubing hanger and AID (e.g., during machining, coating, inspection etc.). Moreover, when several of such seals are used at different points along the AID they can encounter alignment issues that can negatively impact seal functionality during actuation of the AID.

The present disclosure provides tubing hanger and seal element configurations that help to address such concerns.

### SUMMARY

From one aspect, the present disclosure provides a tubing hanger comprising: an annulus communication cavity having a first access port and a second access port downstream of the first access port; an annulus isolation device (AID) disposed within the annulus communication cavity; and a metal sleeve surrounding the AID and disposed between the AID and a surface defining the annulus communication cavity. The AID is operable to move between a closed position in which fluid communication between the first and second access ports via the annulus communication cavity is prevented and an open position in which fluid communication between the first and second access ports via the annulus communication cavity is permitted. The AID also further comprises one or more metal seal elements that form a dynamic metal-to-metal (MtM) seal with the metal sleeve.

In such an MtM seal the metal seal element provides a sealing interface with the metal sleeve and moves with the AID as it operates between the open and closed positions.

In an embodiment of the above, the metal seal element makes sealing contact with the metal sleeve when the AID is in the closed position and is taken out of sealing contact with the metal sleeve when the AID is moved to the open position.

In a further embodiment of the above, the metal sleeve has an inner surface defining a first cylindrical portion extending to a conical portion that transitions into a second cylindrical portion. The metal seal element provides sealing contact with the first cylindrical portion in the closed position. The metal seal element is moved from the first cylindrical portion in the closed position, along the conical portion, and to the second cylindrical portion in the open position. The second cylindrical portion has a larger diameter than the first cylindrical portion such that the metal seal element no longer makes sealing contact with the inner surface of the metal sleeve in the open position.

In yet a further embodiment of the above, the metal seal element includes a metal seal leg that extends from the AID to make sealing contact with the inner surface of the metal sleeve, and the metal seal leg slides against the first cylindrical portion and the conical portion as the AID moves between the closed and open positions.

In a further embodiment of any of the above, the metal sleeve includes a coating to lower the friction experienced between the metal sleeve and the metal seal element. In one particular embodiment, the coating is a Molybdenum disulphide (MoS₂) coating.

In a further embodiment of any of the above, the metal seal element comprises a base metal material, a silver coating on top of the base metal material, and a Molybdenum disulphide (MoS₂) coating on top of the silver coating.

In a further embodiment of any of the above, a clearance is defined between the metal sleeve and a surface defining the annulus communication cavity, and the metal sleeve includes a seal element providing sealing contact with the metal sleeve and the surface defining the annulus communication cavity across the clearance. In this manner, the seal element can be said to provide a seal between the metal sleeve and the surface defining the annulus communication cavity that is disposed in the clearance between the two. In examples, the seal element can be integral with the metal sleeve, attached thereto, or placed between the metal sleeve and the surface to provide the sealing contact.

In a further embodiment of any of the above, the metal sleeve is comprised of a plurality of tubular sleeve elements that are stacked on top of each other.

In a further embodiment of the above, the metal seal element moves across only one of the plurality of tubular sleeve elements when the AID moves between the closed and open positions.

In a further embodiment of any of the above, the AID extends along a central axis and further comprises: a first actuation component at a first axial end and a second actuation component at an opposing, second axial end for actuating the AID between the closed and open positions; and at least one annulus isolation component that includes the metal seal element and is positioned axially between the first and second actuation components. In a further embodiment, the first and second actuation components each include seal elements (i.e., additional to the metal seal element) that provide sealing contact between the first and second actuation components and the metal sleeve.

In a further embodiment, the tubing hanger further comprises a control passage connected to the annulus communication cavity for supplying hydraulic fluid to actuate movement of the AID.

In a further embodiment of either of the above, at least one of the first and second actuation components are connected to the at least one annulus isolation component via a floating joint that permits radial movement there between.

In a further embodiment of the above, the floating joint includes a male element secured into a corresponding female recess. Radial clearance is defined between the male element and walls defining the female recess to enable the radial movement.

In a further embodiment of the above, at least one of the first actuation component, the second actuation component and the annulus isolation component includes a stem extending axially therefrom to an axial end. The male element or female recess are defined on the axial end of the stem.

From another aspect, the present disclosure provides a wellhead assembly comprising: a wellhead housing defining a central downhole axis; the tubing hanger of the above aspect or any of its embodiments landed within the wellhead housing; a tubing string extending downhole from the tubing hanger; and an annulus defined between the tubing string and the wellhead housing. The annulus communication cavity is disposed within a sidewall of the tubing hanger, the first access port provides fluid communication between an uphole location and the annulus communication cavity, and the second access port provides fluid communication between the annulus communication cavity and the annulus.

From yet another aspect, the present disclosure provides a metal seal element for providing a dynamic metal-to-metal (MtM) seal. The metal seal element comprises a base metal material, a silver coating on top of the base metal material, and a Molybdenum disulphide (MoS₂) coating on top of the silver coating. In one example, the base metal material is a Nickel super alloy.

In an embodiment of the above, the metal seal element defines (e.g., is shaped to provide) a seal leg (e.g., extending therefrom) for providing sealing contact with a metal component.

From yet another aspect, the present disclosure provides a dynamic metal-to-metal (MtM) seal that comprises the metal seal element of the above aspect or any of its embodiments and a metal component. The metal seal element is in sealing contact with the metal component and is moveable there along.

In this manner, the metal seal element forms a dynamic metal-to-metal (MtM) seal with the component with improved wear performance.

In a further embodiment, the metal component includes a Molybdenum disulphide (MoS₂) coating thereon that is in contact with the Molybdenum disulphide (MoS₂) coating of the metal seal element when sealing contact is made there between.

The metal seal element of the above aspects and embodiments can be used generally in any application that requires a dynamic metal-to-metal (MtM) seal with improved wear performance.

Nonetheless, the metal seal element can be particularly suitable for use in downhole environments/oil and gas drilling and production components. For example, the metal seal element can be suitable for use in a wellhead wherever dynamic sealing with a metal component is required. It may be particularly advantageous for use as part of an annulus isolation device (“AID”) in a tubing hanger, such as discussed in the above aspect and embodiments thereof.

Although certain advantages are discussed below in relation to the features detailed above, other advantages of these features may become apparent to the skilled person following the present disclosure.

### BRIEF DESCRIPTION OF DRAWINGS

One or more non-limiting examples will now be described, by way of example only, and with reference to the accompanying figures in which:

FIG. 1 shows a schematic cross-sectional view of an example, known wellhead assembly including a tubing hanger with a different AID design to that of the embodiments of the present disclosure;

FIG. 2A shows a schematic cross-sectional view of a tubing hanger in accordance with an embodiment of the present disclosure with the AID in a closed position;

FIG. 2B shows the tubing hanger of FIG. 2A with the AID in an open position;

FIG. 3A shows a schematic cross-section of a portion of a sleeve from a tubing hanger and a metal seal element in accordance with an embodiment of the present disclosure with the metal seal element in a closed position;

FIG. 3B shows the portion of the sleeve and metal seal element of FIG. 3A with the metal seal element in an open position.

FIG. 4A shows a schematic cross-sectional view of a tubing hanger in accordance with another embodiment of the present disclosure with the AID in a closed position;

FIG. 4B shows the tubing hanger of FIG. 4A with the AID in an open position;

### DETAILED DESCRIPTION

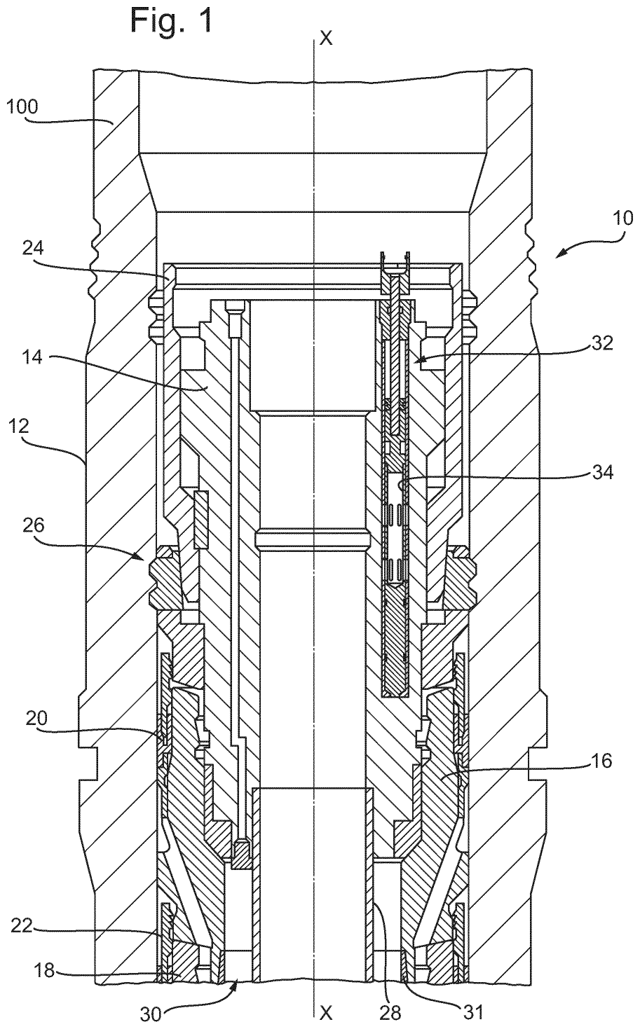

FIG. 1 shows in cross sectional view one example of a known wellhead assembly 10. The wellhead assembly 10 comprises an annular wellhead housing 12 defining a central downhole axis X, and a tubing hanger 14 landed therein.

The tubing hanger 14 is an annular member and is shown landed on top of a casing hanger 16, which in turn lands on an outer casing hanger 18 within wellhead housing 12.

Seal assemblies 20, 22 seal the interface between the casing hangers 16, 18 and the wellhead housing 12. Circumscribing an upper portion of tubing hanger 14 is an actuation sleeve 24 shown behind locking dogs 26 that are mounted to an inner surface of wellhead housing 12. Driving actuation sleeve 24 downward pushes the dogs 26 radially outward to lock the tubing hanger 14 in the wellhead assembly 10.

Although this particular locking mechanism is depicted, this is not the focus of the present disclosure, and it should be understood that any other suitable mechanism could be used within the scope of this disclosure.

A tubing string 28 is connected to a lower end of tubing hanger 14 and extends downhole therefrom (i.e., along the downhole axis X) into a well (not shown) that is disposed beneath the wellhead assembly 10.

An annulus 30 is formed between the tubing string 28 and an inner surface of casing hanger 16. A casing 31 is shown mounted on a lower end of casing hanger 16.

An example of a known annulus isolation device (“AID”) 32 is illustrated disposed in an annulus communication cavity 34. The cavity 34 is axially formed within the body of the tubing hanger 14. As will be described in more detail below, the AID 32 acts an annulus access valve that provides selective communication between the annulus 30 and locations above wellhead assembly 10 (i.e., uphole locations). It will be appreciated that the AID and associated components discussed in the embodiments of the present disclosure have a different form to the AID 32 shown in FIG. 1. It is to be understood that the features of these embodiments can be used in the wellhead assembly 10 within the scope of the present disclosure and replace the known AID 32 and associated components thereof.

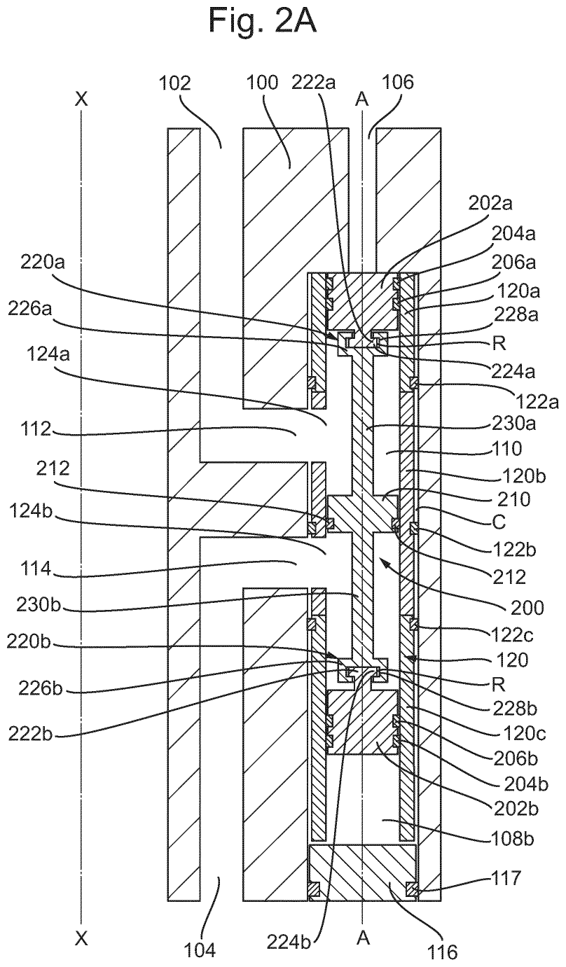

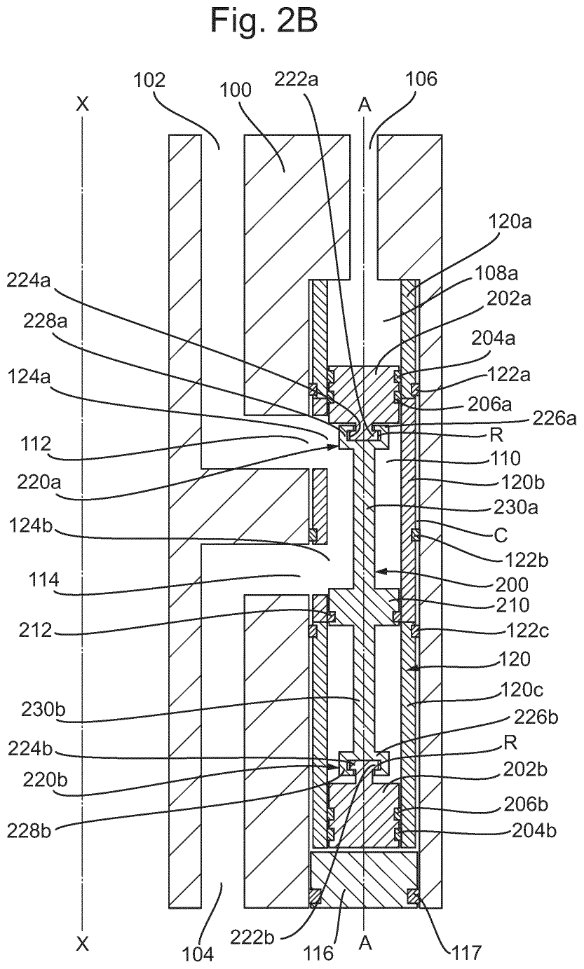

FIGS. 2A and 2B show a portion of a tubing hanger 100 having an AID 200 disposed therein in accordance with embodiments of the present disclosure. The tubing hanger 100 can be utilized in a wellhead assembly 10 as discussed above in relation to FIG. 1 (i.e., and replace tubing hanger 14 therein).

The AID 200 is disposed within an annulus cavity communication cavity 110 that is formed within the body of the tubing hanger 100. The AID 200 and cavity 110 extend axially (i.e., vertically) along a central axis A that is parallel with the downhole axis X. Nonetheless, the AID 200 and cavity 110 can be provided in any suitable alternative orientation (e.g., horizontal/perpendicular to the downhole axis X) as necessary for a particular application. Likewise, the orientation, size and shape of any associated ports and passages (as discussed below) can also be adapted as necessary for a particular application.

The annulus communication cavity 110 includes a first access port 112 and a second access port 114 downstream thereof, which permit fluid to be communicated in and out of the cavity 110. The first access port 112 is connected to an annulus communication cavity access passage 102 that extends uphole through the sidewall of the tubing hanger 100, and the second access port 114 is connected to an annulus access passage 104 that extends downhole through the sidewall of the tubing hanger 100. In this manner, fluid can be communicated in to the cavity 110 from an uphole location via the passage 102 and the port 112, and can subsequently be communicated downhole to the annulus 30 from the cavity 110 by the port 114 and the passage 104. Likewise, in a reverse operation, fluid can be communicated to the cavity 110 from the downhole annulus 30 via the passage 104 and the port 114, and then subsequently communicated towards the uphole location from the cavity 110 via the port 112 and the passage 102.

A mechanical intervention passage 106 extends uphole through the body of the tubing hanger 110 and is connected to (i.e., opens into) the cavity 110. The passage 106 can allow for a mechanical override system to be applied to operate the AID 200 should the normal control fluid mechanism (discussed in more detail below) fail.

At the downhole end of the cavity 110, an end cap 116 is sealed therein using an annular seal 117. The annular seal 117 provides sealing contact between the end cap 116 and a surface defining the cavity 110.

As shown by comparison of FIGS. 2A and 2B, the AID 200 is operable to move between a closed position in which fluid communication between the first and second access ports 112, 114 via the cavity 110 is prevented, and an open position in which fluid communication between the first and second access ports 112, 114 via the cavity 110 is permitted.

In this manner, the AID 200 can be selectively operated to control (e.g., the types, amounts and/or pressure of) annular fluids that are present in the annulus 30 for gas and oil drilling and production operations, as well as allow access thereto for testing and maintenance activities (e.g., on the tubing hanger/a wellhead assembly/wellbore).

In order to move the AID 200 between the closed and open positions, the AID 200 includes a first actuation component 202a and a second actuation 202b at opposing axial ends thereof.

In the depicted embodiment, the actuation components 202a, 202b are pistons that are reactive to hydraulic pressure thereon. Control (i.e., hydraulic) fluid can be supplied to the first actuation component 202a and second actuation component 202b, respectively, to apply biasing pressure thereon to move the AID 200 between the closed and open positions. As shown in FIG. 2A, in the closed position, a varying control volume 108b is defined between the second actuation component 202b and the end cap 116, and as shown in FIG. 2B, in the open position, a varying control volume 108a is defined between the first actuation component 202a and the top surface of the cavity 110. The selective supply and removal of control fluid to the control volumes 108a, 108b can be used to vary the amount of biasing pressure applied to each of the components 202a, 202b and move the AID 200 between the closed and open positions. Respective control fluid passages (not visible in the depicted cross-sections) open into the control volumes 108a, 108b to enable the selective supply and removal of control fluid. Such control fluid passages will be fluidly connected to an uphole location, where the control fluid supply and removal can be controlled. In this manner, the selective supply and removal of control (hydraulic) fluid to the opposed axial ends of the AID 200 can be used to actuate movement of the AID 200 between the closed and open positions and vice versa.

Although AID 200 movement has been exemplified as being actuated by hydraulic means, it should be appreciated that any other suitable actuation means can used. For example, an electromechanical means, such as a solenoid valve or a suitable linear actuator. Such a means could be provided in the passage 106, for example. As will be appreciated, such control systems could be selectively operated by electrical connection to an uphole location.

In contrast to known designs, the tubing hanger 100 includes a metal sleeve 120 that surrounds the AID 200 and is disposed within the cavity 110 between the AID 200 and the surface defining the cavity 110. The sleeve 120 is substantially tubular. A clearance C is defined between the metal sleeve 120 and the surface defining the cavity 110. The metal sleeve 120 includes a seal element 122 that is used to seal the metal sleeve 120 in place within the cavity 110 around the AID 200. In other words, the seal element 122 provides sealing contact with the metal sleeve 120 and the surface defining the cavity 110 across the clearance C. It will be appreciated that in the depicted orientation, the clearance C is a radial clearance between the sleeve 120 and the cavity surface, relative to the AID central axis A.

Openings 124a, 124b are formed in the sleeve 120 which are in registry with the access ports 112, 114 to permit fluid communication from the ports 112, 114 to the cavity 110.

Although a single-piece sleeve 120 can be used within the scope of the present disclosure, the depicted embodiments show the metal sleeve 120 being comprised of a plurality of tubular sleeve elements 120a, 120b, 120c that are stacked on top of each other. Each sleeve element 120a, 120b, 120c includes a respective seal 122a, 122b, 122c to seal it in place against the surface of the cavity 110. The seals 122a, 122b, 122c are static seals that can include any suitable number of seal elements (e.g., a plurality of seal elements providing a plurality of seals at each location 122a, 122b, 122c).

As will be discussed more below, using a sleeve, and in particular a plurality of sleeve elements 120a-120c can provide cost, repair and maintenance benefits compared to known designs that do not include a sleeve.

When the tubing hanger 100 is being assembled, the end cap 116 is removed and the sleeve 120 (or portions 120a-120c thereof) can be stacked up in the cavity 110. The seals 122a, 122b, 122c can be “energized” against the surface of the cavity 110 to lock the sleeve 120 (or portions 120a-120c thereof) in place during the stacking. Once stacking is complete, and the sleeve 120 (or portions 120a-120c thereof) are sealed in place within the cavity, the AID 200 can be positioned therein and the end cap 116 with seal 117 can be replaced to seal the cavity 110.

Although three sleeve portions 120a, 120b, 120c are shown, it will be appreciated that any suitable number of sleeve portions (i.e., one or more) can be used within the scope of the present disclosure.

The AID 200 comprises a metal seal element 212 that is in sealing contact with the metal sleeve 120 in the closed position. In particular, the metal seal element 212 is in sealing contact with the single sleeve portion 120b in the closed position. The metal seal element 212 moves with the AID 200 as it operates between the closed and open positions and only moves across the sleeve portion 120b. The metal seal element 212 is thus a dynamic seal element, and forms a dynamic metal-to-metal seal (MtM) with the sleeve 120 (and sleeve portion 120b in particular).

The AID 200 includes an annulus isolation component 210 that includes the metal seal element 212 and is positioned axially (i.e., vertically) between the first and second actuation components 202a, 202b. In the depicted embodiment, the annulus isolation component 210 is a radially extending land and the seal element 212 is annular and surrounds the radial periphery (i.e., circumference) of the land.

The seal element 212 is attached to the component 210, and acts to form a seal between the component 210 and the sleeve 120. As can be seen in FIG. 2A, in the closed position it is this seal that acts to isolate the annulus 30 from the uphole location, by blocking fluid communication between the ports 112, 114 via the cavity 110. As can be seen in FIG. 2B, in the open position, this seal not long acts to isolate the annulus 30, as it is moved below the port 114, to permit fluid communication thereto from the port 112 via the cavity 110. Accordingly, the annulus isolation component 210 is the AID component that provides the seal that controls isolation of the annulus 30.

Although only metal seal element 212 is shown in FIGS. 2A and 2B, it is to be understood that further secondary seal elements may be provided in conjunction therewith at the location 212. Such secondary seal elements may be non-metallic.

By utilising the combination of the metal seal element 212 and metal sleeve 120 to provide a dynamic metal-to-metal (MtM) seal, a cheaper and easier to maintain selective annulus isolation mechanism is achieved.

For example, previous known solutions typically provide a seal element that makes sealing contact between an AID and the surface of the cavity 110 directly. This means that the cavity 110 must be designed and made to a very tight tolerance/specification in order to provide a reliable seal with the sealing element. In contrast, in the embodiments of the present disclosure, only the sleeve 120 (and in particular only the sleeve portion 120b in contact with the metal seal element 212) needs to be made to such a high tolerance/specification. Manufacturing such a sleeve portion is much easier and cheaper than previous known solutions, and allows the application of low friction coatings thereto (discussed further below). Visual inspection and repair and maintenance of the sleeve portion is also much cheaper and simpler (e.g., compared to having to rework the body of the tubing hanger 14).

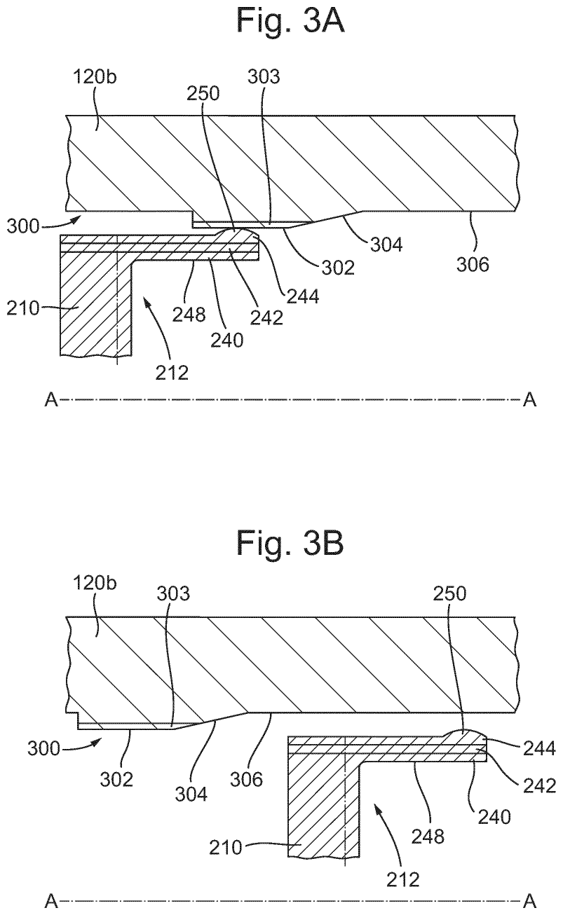

Moreover, implementing the metal seal element 212 and metal sleeve 120 to provide a dynamic metal-to-metal (MtM) seal can improve the robustness and wear properties of the seal in the cavity 110. Such a dynamic metal-to-metal (MtM) seal can help ensure the seal can cope with the relatively high pressure and more chemically aggressive nature of annular fluids communicating with the cavity 110 (e.g., compared to other types of dynamic seals (such as non-metallic dynamic seals)). As discussed further below with reference to FIGS. 3A and 3B, the sleeve 120/portion 120b along which the seal element 212 moves can optionally include a coating that lowers the friction experienced between the sleeve 120 and the metal seal element 212. This can help improve the wear characteristics of the seal between the two further. In one example, the coating is a Molydenum disulphide (MoS₂) coating, but any other suitable friction reducing coating or layer could be used, such as another dry lubricant film or coating, such as PTFE (or other fluoropolymer-based lubricant coating) or graphite.

Each of the first and second actuation components 202a, 202b also include dynamic seal elements 204a, 204b, 206a, 206b that provide sealing contact between the first and second actuation components 202a, 202b and the metal sleeve 120 (i.e., sleeve portions 120a, 120c, respectively). In particular, seal elements 204a, 206a are connect to the component 202a and move therewith along the sleeve portion 120a, and seal elements 204b, 206b are connected to the component 202b and move therewith along the sleeve portion 120c.

Although only single seal elements providing seals at each location 204a, 206a, 204b, 206b are discussed below, any suitable number of seal elements can be provided at each location 204a, 206a, 204b, 206b (e.g., a plurality of seal elements providing a plurality of seals at each location 204, a 206a, 204b, 206b) can be provided within the scope of the present disclosure.

Having a pair of seal elements 204, 206 on each component 202a, 202b can provide additional redundancy and allow different types of seal elements to be used that better suit the fluid conditions they will be exposed to. For example, seal elements 204a, 204b come into contact with hydraulic control fluid, whereas seal elements 206a, 206b come into contact with annular fluids from the cavity 110. Depending on the fluid concerned, the different seals 204a/b, 206a/b may need to deal with higher pressure or more chemically aggressive environments. Accordingly, the design of the seal elements 206a, 206b will differ from seal elements 204a, 204b. For example, whereas seal elements 204a, 204b can be dynamic elastomeric seal elements, the seal elements 206a, 206b may need to be polymeric or metallic in nature and/or have the same construction as that of the metal seal element 212. In this manner, the seal elements 206a, 206b may provide the same metal-to-metal (MtM) seal as provided by the seal element 212 discussed above.

Of course, the skilled person will be aware of other suitable seal element types for such conditions, depending on the actuation forces, control/annular fluids and downhole environment involved. Accordingly, all such types of seal elements are envisaged within the scope of the present disclosure.

The first and second actuation components 202a, 202b are connected to the annulus isolation component 210 by floating joints 220a, 220b. The floating joints 220a, 220b are so-called because they permit some movement or play within the joint without losing connection.

In the depicted embodiment, each of the floating joints 220a, 220b are formed by a male element 222a, 222b that is secured into a corresponding (i.e., complementary) female recess. In the depicted embodiment, the female recess is defined by a hook element 226a, 226b, which secures around a T-shaped male element 222a, 222b. A radial clearance R is defined between the radial ends 224a, 224b of the T-shaped male element 222a, 222b and radial walls 228a, 228b of the hook element 226a, 226b that define the female recess. Each male element 222a, 222b has two opposed radial ends 224a, 224b, and each female recess is defined between two opposed radial walls 228a, 228b of the hook elements 226a, 226b. As will be appreciated, the radial clearance R allows the male element 222a, 222b to have some movement/play within the female recess without disconnecting from the joint.

The floating joints 220a, 220b permit self-alignment of the seal elements 204a, 204b, 206a, 206b, 210 within the sleeve 120 when the components 202a, 202b, 210 are assembled therein and as they move there along during operation. This means manufacturing tolerances (and thus costs) for these components can be lowered, without comprising the sealing contact between them. It can also make assembly of the AID 200 into the cavity 110 easier and its operation smoother. The floating joints 220a, 220b are defined on the axial ends of stems 230a, 230b that extend axially from the annulus isolation component 210 towards the first and second actuation components 202a, 202b, respectively. Stems 230a, 230b take the form of axially extending shafts. This form can maximize the fluid flow area defined between the inner diameter (ID) of the sleeve 120 and the outer diameter (OD) of the stems 230a, 230b, which can reduce pressure losses and maximize fluid flow rate through the cavity 110. Although stems 230a, 230b are shown extending from the annulus isolation component 210 in the depicted embodiment, stems could additionally or alternatively extend from either or both of the actuation components 202a, 202b. Indeed, in some embodiments, stems extending from the components 202a, 202b could meet at the floating joints 220a, 220b with stems extending from the component 210.

Although the depicted floating joints 220a, 220b are of a T-shaped male-female joint type, any other suitable type and form of floating joint that links the components 202a, 202b, 210 in the axial direction but permits radial movement between them can be utilized within the scope of the present disclosure. Moreover, the male and female sides of the joint can be positioned either way round (e.g., the male element can extend from either the annulus isolation component 210 or the actuation components 202a, 202b, with the corresponding female element extend from the other of the components).

Moreover, although both actuation components 202a, 202b are shown connected to the annulus isolation component 210 by floating joints 220a, 220b this needn't be the case. For example, in another embodiment, one of components 202a, 202b is connected by a floating joint 220a, 220b, whilst the other omits it and is connected by a non-floating joint or without a joint. In yet another embodiment, the floating joints 220a, 220b are both omitted, and the components 202a, 202b, 210 can be connected by non-floating joints or without joints altogether. In the latter example, the components 202a, 202b, 210 can be connected via integral stems that extend axially therefrom, but do not present any joints. In such an example, the components 202a, 202b, 210 and stems connecting them can be formed as a single piece component. It is to be appreciated that the present disclosure extends to cover any such combination of joint or non-joint/integral connections between the different components 202a, 202b, 210. FIGS. 3A and 3B show a magnified, schematic cross-sectional view of the metal seal element 212 interfacing with the sleeve portion 120b in accordance with an embodiment of the present disclosure. Moreover, FIGS. 3A and 3B schematically show a particular construction of the metal seal element 212 in accordance with an aspect of the present disclosure. In the depicted embodiment, the metal seal element 212 comprises a base metal material 240 with a silver coating 242 on top of the base metal material 240, and a Molybdenum disulphide (MoS₂) coating 244 on top of the silver coating 242. The silver coating 242 can be deposited on the base metal material 240 in any suitable known manner, such as by electroplating. The Molybdenum disulphide (MoS₂) coating 244 can be deposited on the silver coating 242 in any suitable known manner, such as by physical vapour deposition (PVD), chemical vapour deposition (CVD) or atomic layer deposition (ALD).

This particular construction of metal seal element 212 is thought to provide particularly low friction and wear resistant properties for dynamic metal-to-metal (MtM) seal applications. It is particularly useful for the conditions experienced in gas and oil field applications (such as in the wellhead and tubing hanger applications discussed above), but may be also be useful for any other industrial or engineering application where reduced friction and wear is required in a dynamic metal-to-metal (MtM) seal. In such applications, the metal seal element 212 can be used in conjunction with a general metal component (i.e., rather than metal sleeve 120/sleeve portion 120b as described above and below).

The base metal material 240, as well as e.g., the AID 202, component 210 and metal sleeve 120, can be made of any suitable metal material. In oil and gas applications, such a metal material may need to be resistant to subsea and/or downhole conditions and so needs to be relatively strong and temperature resistant. Such a metal material may include Nickel based superalloys, such as Inconel 718. Of course any other metal materials, such as stainless steel or titanium alloys, can be used where appropriate for a given application.

In the depicted embodiment, the seal element 212 includes a metal seal leg 248 that extends from the AID 200 to make sealing contact with an inner surface 300 of the metal sleeve 120. In particular, the seal element 212 is either integral to, or secured to (e.g., along the dotted line), the annulus isolation component 210, and the seal leg 248 extends axially therefrom. The seal leg 248 interfaces with the inner surface 300 of the sleeve portion 120b. In particular, the seal leg 248 includes a protrusion 250 that extends radially from the seal leg 248 for making sealing contact with the inner surface 300 of the sleeve portion 120b.

It is to be appreciated that although only part of the cross-section of the seal element 212 is shown FIGS. 3A and 3B for clarity, the seal element 212 extends generally annularly about the AID central axis A and interfaces with the inner surface 300 around the circumference defined by the inner diameter (ID) of sleeve portion 120b.

Although a particularly simple form of seal element 212 is shown in FIGS. 3A and 3B it should be understood that it may take any other suitable shape or form within the scope of the present disclosure. For example, rather than having a single, axially extending leg 248, the seal element 212 may have a plurality of legs that define a U-shaped or more complex cross-section. In one such U-shaped example, a base of the U-shaped seal element 212 can extend from the annulus isolation component 210 and two parallel axially extending legs can provide sealing contact between the sleeve portion 120b and the stem 230a.

As discussed further below, in the depicted embodiment, the metal seal element 212 is configured to be in sealing contact with the sleeve portion 120b when the AID 200 is in the closed position and then taken out of sealing contact with the sleeve portion 120b when the AID 200 is moved from the closed position to the open position. In the depicted embodiment, the geometry and stiffness of the seal leg 248 provides a resilient force that urges the seal leg 248 into sealing contact against the inner surface 300 of the sleeve portion 120b in the closed position.

The inner surface 300 of the metal sleeve portion 120b defines a first cylindrical portion 302 that extends to a conical portion 304 and that transitions into a second cylindrical portion 306. In the closed position, the first cylindrical portion 302 interacts with the metal seal element 212 to provide sealing contact therewith. In the depicted embodiment, the sealing contact is made with the seal leg 248 (and in particular the protrusion 250), which is urged against the first cylindrical portion 302 (owing to the configuration of the seal leg 248 discussed above). As shown across FIGS. 3A and 3B, when the AID 200 is moved from the closed to the open position, the seal element 212 is moved from the first cylindrical portion 302, along the conical portion 304, to the second cylindrical portion 306. The second cylindrical portion 306 has a larger diameter than the first cylindrical portion 302 such that the metal seal element 212 no longer makes sealing contact with the inner surface 300 of the metal sleeve portion 120b in the open position. The conical portion 304 provides a transition between the diameters of the first and second cylindrical portions 302, 306.

As the seal element 212 moves, the metal seal leg 248 slides against the first cylindrical portion 302 and the conical portion 304 until the diameter is sufficient to take the seal leg 248 out of sealing contact therewith. In particular, the protrusion 250 makes the contact and slides there against. When the AID 200 is moved from the open to the closed position, the seal leg 248/protrusion 250 is brought back into contact with the inner surface 300 as the conical portion 304 diameter reduces, and the sliding movement is provided in reverse.

As depicted, the protrusion 250 can be shaped to aid sealing and movement. For example, it may be shaped in the form of a rounded lobe. In other examples, the protrusion 250 made be shaped and/or radiused in any other suitable manner, such as to provide a conical (or otherwise) profiled sealing surface (e.g., to complement that of the sleeve portion 120b) with radiuses sides.

By taking the seal element 212 out of sealing contact during AID 200 movement, the friction and thus resistance to AID 200 movement can be reduced. This can mean smaller actuation loads are required to move the AID 200 and reduce seal wear and the potential for damage during operation. This can further improve operational seal lifetime.

Nevertheless, in other embodiments within the scope of this disclosure, the seal element 212 need not be removed from sealing contact in the transition between the closed and open positions, and can remain in sealing contact in both the closed and open AID positions. In such embodiments, the sleeve portion 120b instead features a single cylindrical portion of constant diameter that seal element 212 moves along. Although this may mean higher actuation loads and seal wear during AID movement, it may simplify the construction of the sleeve portion 120b.

Moreover, as mentioned above, although one particularly effective configuration of seal element 212 is depicted, any other suitable geometry and configuration of seal element 212 may be used, as long as it is effective at providing the necessary sealing contact between the metal sleeve 120/sleeve portion 120b. The protrusion 250 may also take any other suitable shape or may be omitted.

As mentioned briefly above with reference to FIGS. 2A and 2B, the sleeve portion 120b includes a coating 303 that lowers the friction between the sleeve portion 120b and the seal element 212 as it moves there across and is in sealing contact therewith. The coating 303 can further help reduce actuation loads and seal wear.

In one particular embodiment, and as also mentioned briefly above with reference to FIGS. 2A and 2B, the coating is a Molybdenum disulphide (MoS₂) coating 303. In such an embodiment, the Molybdenum disulphide (MoS₂) coating 244 on top of the silver coating 242 of the seal element 212 will make sealing contact with the Molybdenum disulphide (MoS₂) coating 303 on the sleeve portion 120b. It is thought this specific combination of coatings and contact between the same is particularly effective at reducing friction and seal wear. The coating 303 can be deposited on the sleeve 120b by any suitable known method, such as by PVD, CVD or ALD.

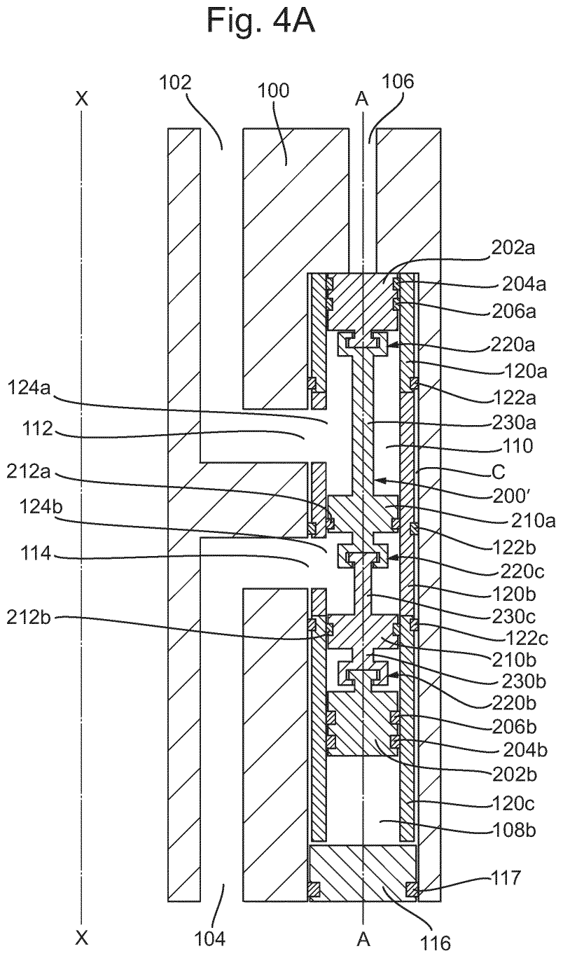

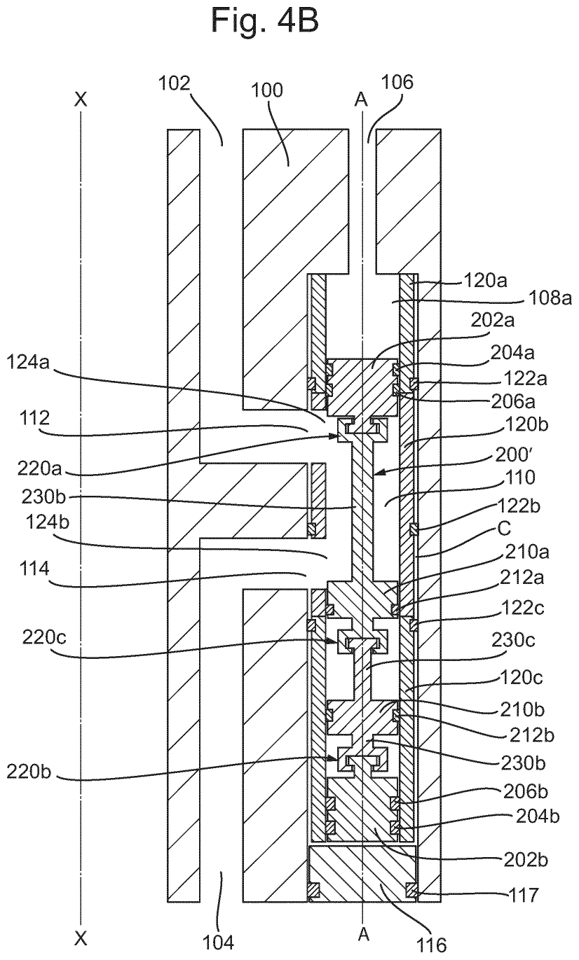

FIGS. 4A and 4B show another embodiment, similar to that of FIGS. 2A and 2B (where like elements are denoted by the same reference numbers). In contrast to the AID 200 in FIGS. 2A and 2B, the AID 200′ in FIGS. 4A and 4B includes a first annulus isolation component 210a and a second annulus isolation component 210b with respective metal seal elements 212a, 212b interfacing with respective sleeve portions 120b, 120c (in the same manner as discussed above with metal seal element 212 and annulus isolation component 210).

The first and second annulus isolation components 210a, 210b are spaced axially apart such that in the closed position they are axially spaced apart across the opening 124b and the second access port 114. In particular, as shown in FIG. 4A, the first annulus isolation component 210a is positioned above the opening 124b and the second access port 114 and the second annulus isolation component 210b is positioned below the opening 124b and the second access port 114. In the open position, as shown in FIG. 4B, both the first and second annulus isolation components 210a, 210b are positioned below the opening 124b and the second access port 114.

In the depicted embodiment, the first and second annulus isolation components 210a, 210b are connected by a further floating joint 220c. This is defined on the axial end of a stem 230c extending axially from the second annulus isolation component 210b towards the first annulus isolation component 210a. In other examples, the stem 230c can extend from the first annulus isolation component 210a instead, or stems can extend from both the first and second components 210a, 210b. In yet further examples, the floating joint 220c can be omitted and the components 210a, 210b can be joined without. For example, by a single stem extending between the two and integral therewith.

The use of the additional, second annulus isolation component 210b ensures that when the AID 200′ is closed the annulus fluid in the cavity 110 is advantageously contained between two primary metal-to-metal (MtM) seals (i.e., either side of the second access port 114). In other words, the annulus 30 is fully sealed by opposing primary metal-to-metal (MtM) seals in the closed position.

Although certain embodiments have been described and depicted, these are by way of example only, and various modifications and alternative embodiments may fall within the scope of the present disclosure as defined by the appended claims.

1. A tubing hanger comprising:
an annulus communication cavity having a first access port and a second access port downstream of the first access port;
an annulus isolation device (AID) disposed within the annulus communication cavity, wherein the AID is operable to move between a closed position in which fluid communication between the first and second access ports via the annulus communication cavity is prevented and an open position in which fluid communication between the first and second access ports via the annulus communication cavity is permitted; and
a metal sleeve surrounding the AID and disposed between the AID and a surface defining the annulus communication cavity;
wherein the AID further comprises one or more metal seal elements that form a dynamic metal-to-metal (MtM) seal with the metal sleeve.

2. The tubing hanger of claim 1, wherein the metal seal element makes sealing contact with the metal sleeve when the AID is in the closed position and is taken out of sealing contact with the metal sleeve when the AID is moved to the open position.

3. The tubing hanger of claim 2, wherein the metal sleeve has an inner surface defining a first cylindrical portion extending to a conical portion that transitions into a second cylindrical portion, wherein:
the metal seal element provides sealing contact with the first cylindrical portion in the closed position;
the metal seal element is moved from the first cylindrical portion in the closed position, along the conical portion, and to the second cylindrical portion in the open position; and
the second cylindrical portion has a larger diameter than the first cylindrical portion such that the metal seal element no longer makes sealing contact with the inner surface of the metal sleeve in the open position.

4. The tubing hanger of claim 3, wherein the metal seal element includes a metal seal leg that extends from the AID to make sealing contact with the inner surface of the metal sleeve, and the metal seal leg slides against the first cylindrical portion and the conical portion as the AID moves between the closed and open positions.

5. The tubing hanger of claim 1, wherein the metal sleeve includes a coating to lower the friction experienced between the metal sleeve and the metal seal element.

6. The tubing hanger of claim 5, wherein the coating is a Molybdenum disulphide coating.

7. The tubing hanger of claim 1, wherein the metal seal element comprises a base metal material, a silver coating on top of the base metal material, and a Molybdenum disulphide coating on top of the silver coating.

8. The tubing hanger of claim , wherein a clearance is defined between the metal sleeve and a surface defining the annulus communication cavity, and the metal sleeve includes a seal element providing sealing contact with the metal sleeve and the surface defining the annulus communication cavity across the clearance.

9. The tubing hanger of claim 1, wherein the metal sleeve is comprised of a plurality of tubular sleeve elements that are stacked on top of each other.

10. The tubing hanger of claim 9, wherein the metal seal element moves across only one of the plurality of tubular sleeve elements when the AID moves between the closed and open positions.

11. The tubing hanger of claim 1, wherein the AID extends along a central axis and further comprises:
a first actuation component at a first axial end and a second actuation component at an opposing, second axial end for actuating the AID between the closed and open positions; and
at least one annulus isolation component that includes the metal seal element and is positioned axially between the first and second actuation components.

12. The tubing hanger of claim 11, further comprising a control passage connected to the annulus communication cavity for supplying hydraulic fluid to actuate movement of the AID.

13. The tubing hanger of claim 11, wherein at least one of the first and second actuation components are connected to the at least one annulus isolation component via a floating joint that permits radial movement there between.

14. The tubing hanger of claim 13, wherein the floating joint includes a male element secured into a corresponding female recess, wherein there is a radial clearance defined between the male element and walls defining the female recess to enable the radial movement.

15. The tubing hanger of claim 14, wherein at least one of the first actuation component, the second actuation component and the annulus isolation component includes a stem extending axially therefrom to an axial end, and the male element or female recess are defined on the axial end of the stem.

16. A wellhead assembly comprising:
a wellhead housing defining a central downhole axis;
the tubing hanger of claim 1, landed within the wellhead housing;
a tubing string extending downhole from the tubing hanger; and
an annulus defined between the tubing string and the wellhead housing, wherein the annulus communication cavity is disposed within a sidewall of the tubing hanger, the first access port provides fluid communication between an uphole location and the annulus communication cavity, and the second access port provides fluid communication between the annulus communication cavity and the annulus.

17. A metal seal element for providing a dynamic metal-to-metal (MtM) seal, the metal seal element comprising a base metal material, a silver coating on top of the base metal material, and a Molybdenum disulphide coating on top of the silver coating.

18. The metal seal element of claim 17, wherein the metal seal element defines an extending seal leg for providing sealing contact with a metal component.

19. A dynamic metal-to-metal (MtM) seal comprising the metal seal element of claim 17 and a metal component, wherein the metal seal element is in sealing contact with the metal component and is moveable there along.

20. The dynamic metal-to-metal (MtM) seal of claim 19, wherein the metal component includes a Molybdenum disulphide coating thereon that is in contact with the Molybdenum disulphide coating of the metal seal element when sealing contact is made there between.
